(19) United States
(12) Patent Application Publication
(10) Pub. No.: US 2018/0154454 A1
(43) Pub. Date: Jun. 7, 2018

(54) EXPANDING CLAMPING SLEEVE, TOOLHOLDER HAVING SUCH AN EXPANDING CLAMPING SLEEVE AND METHOD FOR CLAMPING A TOOL

(71) Applicant: Kennametal Inc., Latrobe, PA (US)

(72) Inventors: Sebastian KUNSCHIR, Winklarn (DE); Michael HACKER, Nurnberg (DE); Günter EBERT, Lichtenau (DE)

(21) Appl. No.: 15/834,542

(22) Filed: Dec. 7, 2017

(30) Foreign Application Priority Data
Dec. 7, 2016 (DE) 102016123728.0

(51) Int. Cl. B23B 31/30

(52) U.S. Cl. CPC B23B 31/305; B23B 31/302

(57) ABSTRACT

The invention relates to an expanding clamping sleeve for an expanding chuck having a first and a second bearing section, a clamping section that can grasp a tool, and a thrust section that is arranged between the clamping section and the first bearing section. The invention further relates to a toolholder having such an expanding clamping sleeve, wherein a contact surface is provided for a tool-side stop. The invention finally relates to a method for clamping a tool using an expanding chuck, in which, in a first step, a shaft of the tool is inserted into the expanding chuck, then the expanding chuck is subjected to pressure so that a clamping section of the expanding chuck clamps the tool shaft in the radial direction, and a thrust section of the expanding chuck displaces the tool shaft in the axial direction so that a tool-side stop is forced against a contact surface of a toolholder with an axial minimum clamping force.

### RELATED APPLICATION DATA

The present application claims priority pursuant to 35 U.S.C. § 119(a) to German Patent Application Number 10 2016 123 728.0 filed Dec. 7, 2016 which is hereby incorporated by reference in its entirety.

### FIELD

The invention relates to an expanding clamping sleeve for an expanding chuck having a first and a second bearing section, as well as a clamping section that can grip a toolshaft. The invention further relates to a toolholder having such an expanding clamping sleeve, as well as to a method for clamping a tool.

### BACKGROUND

Expanding chucks for tool machines are generally known in the prior art. They serve to clamp a tool into a toolholder. Generally speaking, they all have a pressure chamber that can be acted upon using a medium under high pressure (generally hydraulic fluid) so that the expanding clamping sleeve is elastically deformed. It thereby grips a shaft of the tool that is inserted into the expanding clamping sleeve. This results in a frictionally locking connection between the tool shaft and the expanding clamping sleeve.

In addition, mechanical locking means can be used to stop the tool shaft in a specified position and/or to increase the transmittable torque.

The advantage of hydraulic expanding chucks is that the tools can be reliably clamped with little effort. The disadvantage, however, is that the stiffness with which the tool is held in the expanding chuck is not optimal for all applications. In addition, the expanding chuck must have comparatively large dimensions in order to increase the stiffness. Therefore, toolholders that rely on the engagement of two conical surfaces with one another are used for some applications, for example machining valve seats.

### SUMMARY

The object of the invention is to create an expanding chuck that has small dimensions and makes it possible to clamp a tool under high stiffness.

To achieve this object, a thrust section that is arranged between the clamping section and the first bearing section is provided on an expanding chuck of the type mentioned above. The object is also achieved by a toolholder having such an expanding clamping sleeve, wherein a contact surface for a tool-side stop is provided. Finally, the aforementioned object is achieved by a method for clamping a tool using an expanding chuck, in which, in a first step, a shaft of the tool is inserted into the expanding chuck, then the expanding chuck is subjected to pressure so that a clamping section of the expanding chuck clamps the tool shaft in the radial direction, and a thrust section of the expanding chuck displaces the clamping section and thus the tool shaft in the axial direction so that a tool-side stop is forced against a contact surface of a toolholder.

The invention is based on the fundamental idea of converting the pressure that operates in the pressure chamber of the expansion chuck into two different deformations of the clamping section: one radial deformation of the clamping section, via which the tool shaft is clamped; and one axial displacement of the clamping section produced by a deformation of the thrust section. Via the axial displacement of the clamping section, the tool shaft and thus the tool are displaced together in the axial direction so that it can be clamped against a tool-side contact surface. The tool-side contact surface can thus serve to increase the torque transmitted between the toolholder and the tool. In particular, however, the tool-side contact surface serves to increase the stiffness with which the tool is clamped in the toolholder.

The thrust section can, as viewed in a cross-section, have at least one leg extending obliquely to the central axis of the clamping section. Using such a geometry, a radial deformation of the leg can be converted with little effort into an axial displacement of the clamping section.

The thrust section preferably has two legs that merge into one another and preferably extend in opposite directions obliquely to the central axis of the clamping section. The two legs together form a bulge so that an open annular chamber on the inner side of the leg is formed around the tool shaft. If a pressure is applied externally, the two legs operate in a manner similar to a knee lever mechanism that moves the clamping section away from the first bearing section.

A relief groove can be provided on the inner side between the two legs in order to minimize a notching effect at this location. Beyond the minimization of the notching effect, the stiffness of the thrust section can be set using the relief groove. For the optimal clamping effect, care must be taken that the clamping section clamps the tool shaft in the radial direction first before the thrust section displaces the clamping section in the axial direction.

It is preferably provided that the thrust section borders the first bearing section. This can, in turn, be supported in the axial direction by a thrust bearing in the toolholder body. In this design, the reaction forces arising from the axial displacement of the clamping section can be supported directly in the toolholder body.

A relief groove can also be provided that borders the thrust section. If the thrust section has two legs, corresponding relief grooves can be provided on the two sides of the thrust section. These, as well as the relief groove provided in the interior, serve to prevent notch stress. In addition, the clamping force can be influenced by the dimensions of the relief groove, with which the thrust section creates the desired axial displacement.

It is preferably provided that the second bearing section is arranged outside the clamping section. This is then advantageous if the second bearing section is established in the toolholder body in the axial direction. This geometry makes it easier for the thrust section to shift itself away from the first bearing section.

It can preferably be provided here that an annular spring section is arranged between the second bearing section and the clamping section that extends substantially in the radial direction. The spring section serves to support the clamping section stiffly in the radial direction, while the desired axial displacement is simultaneously allowed. In accordance with a preferred embodiment, it is provided that the second bearing section has a collar facing the first bearing section. The advantage of this design is that a defined surface is defined for making a pressure-sealed connection of the expanding clamping sleeve to the toolholder body. For example, the expanding clamping sleeve can be soldered to the toolholder body.

The bearing surface provided on the toolholder is preferably a cone. With it, an automatic centering of the tool can be achieved if it is forced against the contact surface by the clamping section. In addition, by virtue of the wedge effect of a cone, the maximum transmittable torque can be greatly increased.

The second bearing surface is preferably held in the toolholder body in a fixed manner by means of its circumferential surface. Under loads, this increases the stiffness in the radial direction with which the tool is held in the toolholder.

The expanding clamping sleeve can in principle be inserted directly into the toolholder body and connected sealed therewith so that the pressure chamber is formed between the expanding clamping sleeve and the toolholder body. Alternatively, it is also possible to arrange a sealing sleeve around the expanding clamping sleeve so that a self-contained expanding chuck is formed that can be used in the manner of a cartridge in a toolholder body.

Advantageous embodiments of the inventions are evident from the dependent claims.

### BRIEF DESCRIPTION OF THE DRAWINGS

The invention will be explained below with reference to an embodiment that is portrayed in the accompanying drawings. In these are shown:

FIG. 1 schematically, a toolholder according to the invention with a tool held within it;

FIG. 2 in an enlarged view, the expanding clamping sleeve held in the toolholder from FIG. 1;

FIG. 3 in a sectional view, an expanding clamping sleeve with the tool shaft held therein before clamping; and

FIG. 4 in a view corresponding to the one in FIG. 3, the expanding clamping sleeve with the tool shaft held therein after clamping.

### DETAILED DESCRIPTION

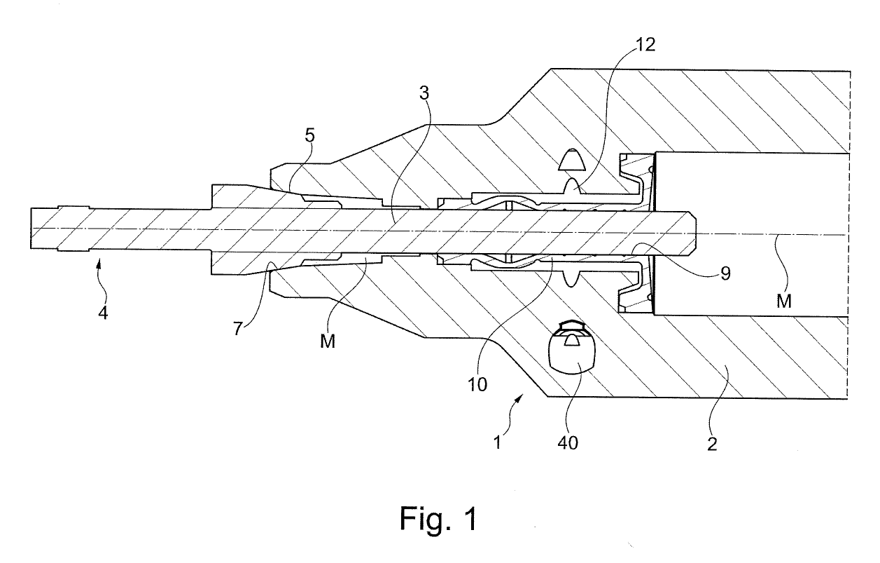

In FIG. 1, a section of a toolholder 1 is shown that has a toolholder body 2. A receiving opening 9 extends centrally through the toolholder, into which a shaft 3 of a tool 4, indicated here schematically, can be inserted.

The tool can be, for example, a drill or a milling cutter. Basically, any machining tool can be inserted that should be precisely clamped so that high torque and bending loads can be transferred.

A stop 5 is provided on tool 4, which in this case is formed as an external cone. If tool 4 is clamped in toolholder 1, stop 5 rests against a contact surface 7 that is provided on the toolholder body. The contact surface is designed in this case as a conical socket. The conical angle of contact surface 7 and of stop 5 are [sic] on the order of 3° to 45°. Alternatively, the stop can also be designed as an axial flat abutment, a conical abutment or as a cylindrical abutment.

Tool 1 is designed in this case as an expanding chuck. For this purpose, an expanding clamping sleeve 10, which defines a compression space 12 between itself and toolholder body 2, is arranged in toolholder body 2. This can be placed under pressure in an inherently known manner via a medium (for example hydraulic fluid) so that tool shaft 3 is clamped in the radial direction within the expanding clamping sleeve.

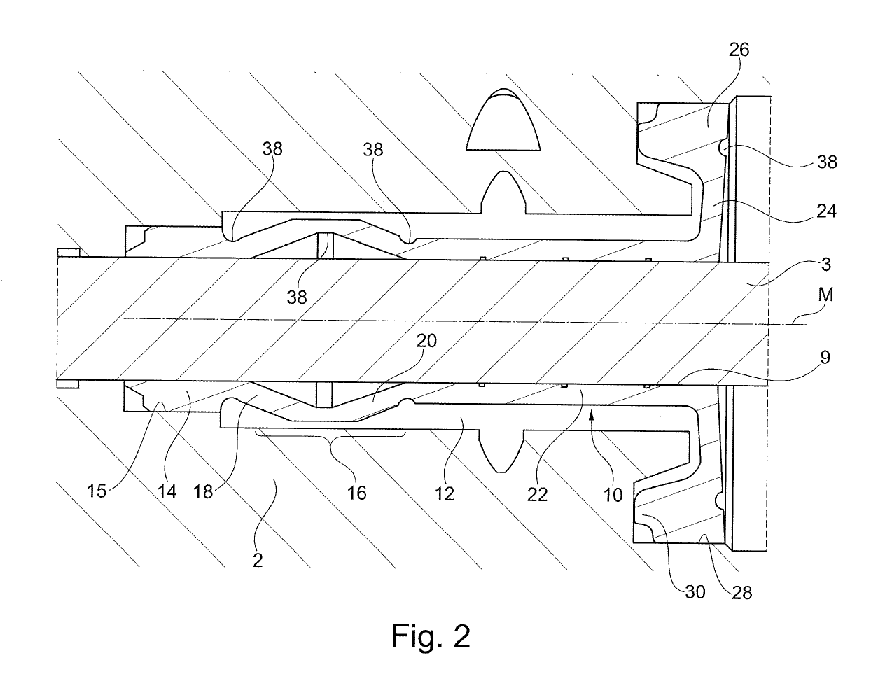

In the following, the design of expanding clamping sleeve 10 is described from left to right with reference to FIG. 2, meaning beginning at the outer side toward the interior of the toolholder.

Expanding clamping sleeve 10 has a first bearing section 14 that is located in a receiving recess 15 in toolholder body 2. First bearing section 14 serves as a boundary of compression space 12 in the axial direction.

The bearing section 14 is an annular ring that is arranged concentrically to central axis M. This also applies to the sections of expanding clamping sleeve 10 that are described below, which also extend sleeve-like along central axis M and concentric thereto.

A thrust section 16 that is formed by two legs 18, 20 arranged obliquely to central axis M connects to first bearing section 14. The first leg 18 extends obliquely outward from first bearing surface 14, while the second leg extends obliquely toward the interior.

The angle of legs 18, 20 relative to the central axis is on the order of 3° to 45°.

A clamping section 22 that is filled as a sleeve having a substantially constant interior diameter adjoins the end of thrust section 16 facing away from first bearing surface 14. The interior diameter of clamping section 22 and of first bearing section 14 substantially defines the diameter of receiving opening 9 that extends through toolholder body 2.

A spring section 24, which substantially extends outward in a radial direction, adjoins the end of clamping section 22 that faces away from the first bearing section. In practice, the spring section can be designed somewhat conically, similar to a disk spring.

The outer circumference of annular spring section 24 adjoins a second bearing section 26. Bearing section 26 has a circumferential surface with which it rests against the outer circumference of a support groove 28 in the radial direction, as well as a collar 30 that faces first bearing section 14 and rests against the base of the receiving groove in the exemplary embodiment shown.

The contact of collar 30 with the base of receiving groove 28 defines compression space 12 on the side facing away from first bearing section 14.

Expanding clamping sleeve 10 is connected in a sealed manner to toolholder body 2 in the region of first bearing section 14 and second bearing section 28. The expanding clamping sleeve can, in particular, be soldered.

Relief grooves 38 can be provided at the transition between first bearing section 14 and first leg 18, at the transition between the two legs 18, 20, at the transition between second leg 20 and clamping section 22 and at the transition from spring section 24 to bearing section 26.

Compression space 12 can be impinged by pressure via a supply hole 40 indicated in FIG. 1. This serves to compress clamping section 22 so that it is clamped against tool shaft 3 in the radial direction.

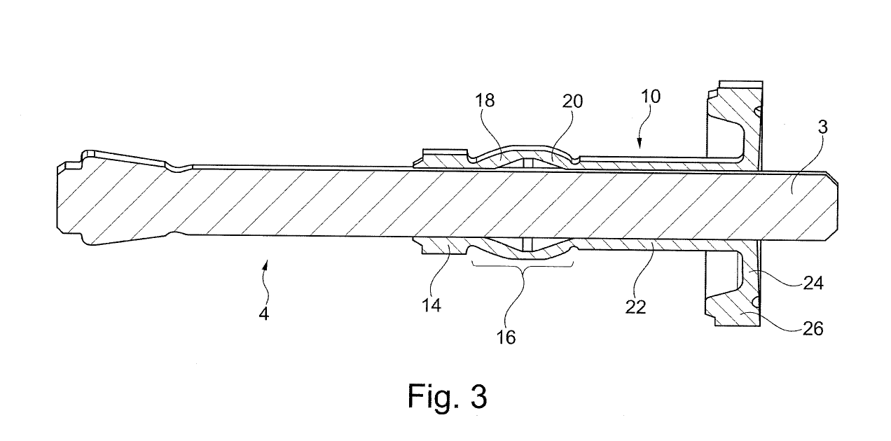

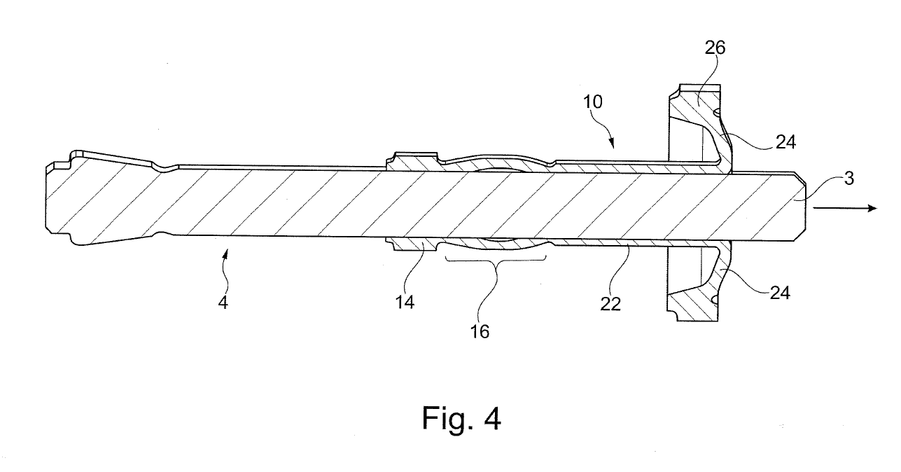

If the pressure in compression space 12 is further increased, legs 18, 20 are also pressed inward toward central axis M. Clamping section 22 is thereby pushed away from first bearing section 14 so that tool shaft 3 clamped in clamping section 22 is also displaced in the axial direction (see arrow P in FIG. 4). This effect can be clearly seen by comparing FIGS. 3 and 4.

Shown in FIG. 3 is the initial state in which thrust section 16 extends outward in a bulging manner around tool shaft 3.

In FIG. 4, it can be seen that thrust section 16 is compressed in the radial direction, whereby clamping section 22 is displaced in the axial direction (with reference to FIG. 4) to the right. This can be seen, in particular, in that spring section 24 at its radially inner circumference is also displaced to the right.

Because of the axial movement of the tool shaft held in the clamping section, stop 5 of tool shaft 3 is drawn in a fixed manner into contact surface 7 of toolholder 1 so that tool 4 is fixed there precisely and with high stiffness.

The deformation of expanding clamping sleeve 10 arising from the clamping is illustrated in FIG. 4 greatly exaggerated for clarification. In practice, the axial stroke of the radially internal end of spring section 24 is on the order of 10 to 100 microns.

1. An expanding clamping sleeve for an expanding chuck, having a first and a second bearing section as well as a clamping section that can grip a tool shaft, characterized by a thrust section that is arranged between the clamping section and the first bearing section.

2. The expanding clamping sleeve according to claim 1, characterized in that the thrust section, seen in a cross-section, has at least one leg extending obliquely to the central axis (M) of the clamping section.

3. The expanding clamping sleeve according to claim 2, characterized in that a plurality of obliquely arranged legs are provided.

4. The expanding clamping sleeve according to claim 2, characterized in that the thrust section has two legs that merge into one another and extend in opposite directions obliquely to the central axis (M) of the clamping section.

5. The expanding clamping sleeve according to claim 4, characterized in that the two legs define a bulge of the expanding clamping sleeve.

6. The expanding clamping sleeve according to claim 4, characterized in that between the two legs, a relief groove is provided on the inner side.

7. The expanding clamping sleeve according to claim 1, characterized in that the thrust section abuts the first bearing section.

8. The expanding clamping sleeve according to claim 1, characterized in that a relief groove abuts the thrust section.

9. The expanding clamping sleeve according to claim 1, characterized in that the second bearing section is arranged radially outside the clamping section.

10. The expanding clamping sleeve according to claim 9, characterized in that between the second bearing section and the clamping section, an annular spring section is arranged extending in an essentially radial direction.

11. The expanding clamping sleeve according to claim 1, characterized in that the second bearing section has a collar facing the first bearing section.

12. An expanding chuck having an expanding clamping sleeve according to claim 1, wherein a sealing sleeve is arranged radially outside the clamping section and the thrust section so that a pressure chamber is defined between the expanding clamping sleeve and the sealing sleeve.

13. A toolholder having an expanding clamping sleeve according to claim 1, characterized in that a contact surface is provided for a tool-side stop.

14. The toolholder according to claim 13, characterized in that the expanding clamping sleeve is held in a toolholder body, and the contact surface is arranged on the toolholder body.

15. The toolholder according to claim 14, characterized in that the contact surface is a cone.

16. The toolholder according to claim 13, characterized in that the first bearing section axially rests against a thrust bearing in the toolholder body.

17. The toolholder according to claim 13, characterized in that the second bearing section is arranged radially outside the clamping section and that between the second bearing section and the clamping section, an annular spring is arranged extending in an essentially radial direction and the second bearing section is held in a fixed manner in the toolholder body via its circumferential surface.

18. A method for clamping a tool using an expanding chuck, in which, in a first step, a shaft of the tool is inserted into the expanding chuck, then the expanding chuck is subjected to pressure so that the clamping section of the expanding chuck clamps the tool shaft in the radial direction, and a thrust section of the expanding chuck displaces the clamping section and the tool shaft is thus displaced in the axial direction, so that a tool-side stop is forced against a contact surface of a toolholder, whereby an axial prestress is created.
